(19) United States
(12) Patent Application Publication
(10) Pub. No.: US 2019/0144181 A1
(43) Pub. Date: May 16, 2019

(54) PRODUCT PRESENTATION ASSEMBLY

(71) Applicant: SERENA FIORELLA, SLEEPY HOLLOW, NY (US)

(72) Inventor: SERENA FIORELLA, SLEEPY HOLLOW, NY (US)

(21) Appl. No.: 15/094,968

(22) Filed: Apr. 8, 2016

(51) Int. Cl. B65D 71/02; A23P 10/10; A47F 7/00; B65D 63/10; B65D 71/00

(52) U.S. Cl. CPC B65D 71/02; A23P 10/10; B65D 71/0085; B65D 63/1009; A47F 7/0071

(57) ABSTRACT

A product presentation assembly is comprised of one or more presentation products enwrapped in a ribbon, said ribbon securing the presentation products by being affixed to itself with adhesive, said adhesive being applied selectively so as to avoid contact with the presentation product, the ribbon then being affixed to a support structure.

### CROSS-REFERENCE TO RELATED APPLICATIONS

This patent application claims priority to U.S. Provisional Patent Application, Ser. No. 62/144,332, filed Apr. 8, 2015, the disclosure of which is incorporated by reference herein in its entirety.

### STATEMENT REGARDING FEDERALLY SPONSORED RESEARCH OR DEVELOPMENT

Not applicable.

### REFERENCE TO COMPACT DISC APPENDIX

Not applicable.

### BACKGROUND OF INVENTION

### Field of the Invention

The present invention relates generally to arrangements of products and, more particularly, to a method of assembling products for display and presentation.

### Background of the Related Art

Gift and product arrangements, such as gift and fruit basket baskets, are well known in the prior art. Arrangements of good and food products are often valued as decorative presentations that are both visually pleasing and consumable. Such arrangements are used in a variety of circumstances. They are purchased to commemorate celebrations, given as gifts on special occasions, and incorporated as component of various promotional or marketing campaigns. They are often offered as prizes in raffles raising funds for a good causes.

These arrangements have gained significant popularity and often replace traditional floral arrangements. With this popularity, there is a need to develop new and improved methods for assembling products arrangements.

Food products included in such edible arrangements, such as biscuits and cookies, are typically flat in conformation.

It is desirable to assemble such food products in a manner that is food-safe, ensuring that edible components do not come into physical contact with any packaging or adhesive that is not food safe. It is further desirable to provide an assembly that is visually interesting and esthetically appealing to both the consumers purchasing such arrangements and the recipients of the arrangements.

Such arrangements containing products intended for consumption by domestic pet animals are also known but less commonly available. Therefore, it is desirable to provide a solution for assembling edible food product arrangements to contain food products suitable for consumption by domestic pet animals.

One common solution involves the use of pre-packaged foods or products placed directly within a container, such as a basket or a box. Due to the crowding of food products, the items in such arrangements are necessarily overlapping, making it difficult to identify the contents or to showcase any individual product. Accordingly, it remains desirable to provide a solution for a product arrangement that allows individual items to remain visible upon presentation.

Another common solution involves packing products within a bag. Without means of maintaining the position of any item in relation to the other products within such a bag, it would be difficult to identify any individual items within the bag. Accordingly, it remains desirable to provide a solution for an edible food product arrangement that maintains individual products in desired positions, allowing each to remain visible upon presentation.

A further solution entails utilizing skewers of perishable food, such as fresh-cut fruit. Food used in this solution must be sufficiently soft to be penetrated by a skewered. This solution could not apply to food that is susceptible to breaking or crumbling when skewered. Accordingly, it remains desirable to provide a solution for arranging food products that, due to their fragile nature, may crack or crumble when handled.

Yet another solution involves attaching packaged items directly to a supportive material. These are often attached by means of an adhesive. It is not desirable to attach unpackaged food items with an adhesive, regardless of the adhesive's food-safe categorization. Accordingly, it remains desirable to provide a solution for securing unpackaged food products to a supportive material that avoids contact between the unpackaged food and any adhesives.

It is, therefore, an object of this invention to provide a product presentation assembly. Another object of this invention is a product arrangement that is food safe, avoiding contact between unpackaged foods and any adhesives used to secure such foods. A further object of this invention is to provide a product arrangement that secures products in a manner that is visually interesting, esthetically appealing, and allows each item in the arrangement to remain individually visible.

### SUMMARY OF INVENTION

Accordingly, the present invention contemplates a new and improved product presentation assembly. The invention eliminates the above-discussed and other drawbacks of the currently employed solutions.

The invention solves the problem of food product arrangements wherein individual food products are difficult to discern by providing a product presentation assembly which positions individual items such that they remain clearly visible.

The invention solves the problem of securing food products that are susceptible to breaking or crumbling by providing a method of assembling food products that will not cause fragile food items to break or crumble.

The invention solves the problem of undesirable contact between food products and adhesives by providing a product presentation assembly that secures food products without direct contact with any adhesive used in the assembly.

The invention solves the problem of versatility by providing a product presentation assembly that is suited to presenting a variety of goods and edible food products, and is capable of holding a range of products simultaneously.

In one embodiment, a product presentation assembly is provided compromising one or more items, enwrapped by a binding material such as a decorative ribbon, an adhesive such as non-toxic hot glue, and a supporting material, such as a rod of wood or other supportive material.

In another embodiment, a product presentation assembly is provided compromising one or more items, a binding material such as a decorative ribbon, an adhesive such as non-toxic hot glue, and a supporting material such as a rod or stick of wood or other supportive material, wherein the ends of the binding material remain free, providing a surface to which decorative items may be attached.

### BRIEF DESCRIPTION OF DRAWINGS

The invention may take physical form in certain parts and arrangements of parts, a preferred embodiment of which will be described in detail in this specification. Other objects and advantages of the invention will become apparent upon reading the following detailed description and upon reference to the accompanying drawing, in which:

FIG. 1A is a front perspective view of a product presentation assembly in accordance with a first embodiment of the present invention.

FIG. 1B is a rear perspective view of the product presentation assembly of FIG. 1A.

FIG. 1C is a side cross sectional view of the product presentation assembly of FIG. 1A.

FIG. 2 is a side cross sectional view of an alternative embodiment of the product presentation assembly in accordance with a second embodiment of the present invention.

### DETAILED DESCRIPTION OF INVENTION

While the invention is susceptible to various modifications and alternative forms, specific embodiments thereof have been shown by way of example in the drawings that are herein described in detail. It should be understood, however, that the description herein to specific embodiments is not intended to limit the invention to the particular forms disclosed, but on the contrary, the intention is to cover all modifications, equivalents, and alternatives falling within the spirit and scope of the invention. It will, of course, be appreciated that in the development of any such actual embodiment, numerous decisions specific to any particular implementation must be made to achieve the developers' goals, such as compliance with regulatory constraints, which will vary from one implementation to another. In the interest of clarity, not all features of an actual implementation are described in this specification. Moreover, it will be appreciated that such development effort might be complex and time-consuming, but would nevertheless be a routine undertaking for those of ordinary skill in the art having the benefit of this disclosure.

The following statements A-D summarize certain aspects of the invention described in this provisional specification. They are not the claims in the sense of 35 U.S.C. § 112:

Statement A: The product presentation assembly is susceptible to use with a variety of goods and food products, referred to herein as presentation products. Each presentation product secured by the assembly may be different, such that any embodiment of the assembly may include a multiplicity of products. By way of example only, the drawings herein depict a plurality of bone-shaped biscuits.

Statement B: The support structure discussed herein may be composed of any sufficiently strong material, including wood, plastic, metal, and cardboard. The support structure may take any of a number of shapes and forms, including stick, rod, board, plank, cone, pyramid, and grate.

Statement C: The adhesive discussed herein may be composed of any compound with sufficient binding properties to secure the components of the product presentation assembly. The adhesive may be approved, specifically, for use in direct contact with food items or, more generally, for use in proximity to food items while precluded from direct contact with unwrapped food items. Each instance of adhesive may be different, such that more than one distinct adhesive may be used in any embodiment of the invention.

Statement D: The binding ribbon discussed herein may be composed of any food-safe material that is sufficiently impermeable to the adhesive. With respect to fabric ribbons, a fabric ribbon with a surface texture, commonly referred to as ‘corded’ or “grosgrain’, is preferred for its improved adhesive binding properties.

Nothing in the descriptions of the embodiments below is intended to be a limitation on the possible materials to be used in assembling any form of this invention.

### First Embodiment

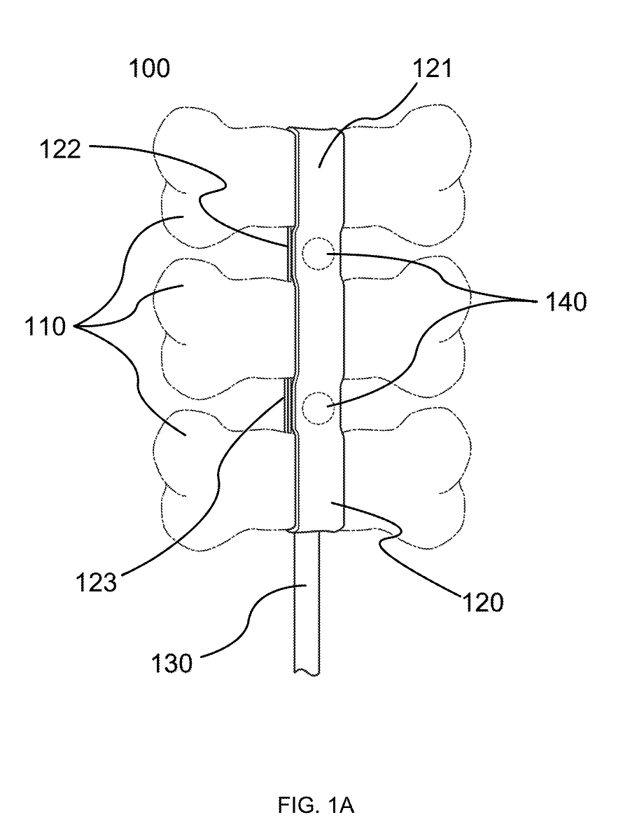

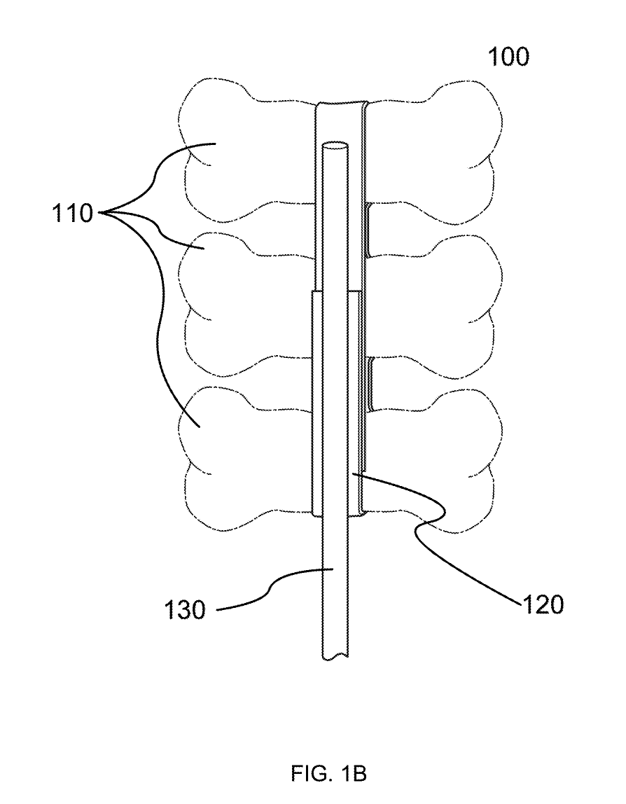

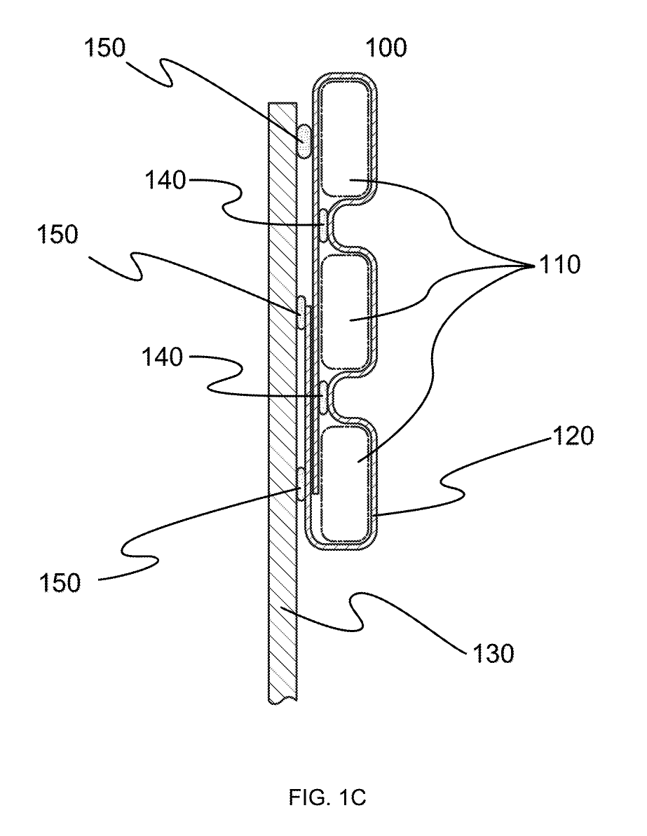

The first embodiment will now be described using any one of FIGS. 1A-1C. In the drawings, the same constituent elements are identified by the same reference numerals.

FIG. 1A is a front perspective view of an embodiment of product presentation assembly 100 holding a plurality of presentation products 110. Presentation products 110 are distributed along a first portion of binding ribbon 120. Binding ribbon 120 is of a length sufficient to enwrap presentation products 110. A first portion of binding ribbon 121 traverses the anterior of presentation products 110.

A second portion of binding ribbon 122 and a third portion of binding ribbon 123 collectively traverse the posterior of presentation products 110. The first portion of binding ribbon 121, second portion of binding ribbon 122 and the third portion of binding ribbon 123 are securely attached to each other. Adhesive 140 is applied to the portion of binding ribbon 121 between presentation products 110. The first portion of binding ribbon 121 comprises the anterior face of product presentation assembly 100.

Presentation products 110 enwrapped by binding ribbon 120 is securely affixed to support structure 130.

FIG. 1B is a rear perspective view of an embodiment of product presentation assembly 100. Binding ribbon 120 enwraps presentation products 110. Binding ribbon 120 is securely affixed to support structure 130.

FIG. 1C is a side sectional view of an embodiment of product presentation assembly 100. Binding ribbon 120 securely enwraps presentation products 110. Ribbon 120 is affixed to itself with applications of adhesive 140 such that adhesive 140 never makes contact with presentation products 110. Presentation products 110 enwrapped in ribbon 120 is then affixed to support structure 130 with applications of adhesive 150.

### Second Embodiment

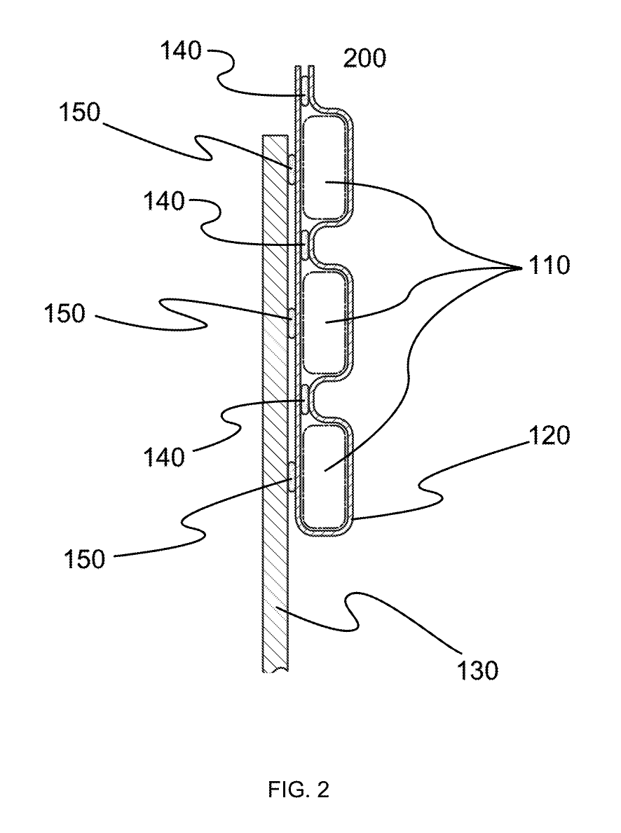

A second embodiment of the present invention will now be described using FIG. 2. Those matters described in the first embodiment but not described in the second embodiment are applicable to this embodiment, unless there are special circumstances.

FIG. 2 is a side cross sectional view of an alternative embodiment of product presentation assembly 200. Binding ribbon 120 securely enwraps presentation products 110. Ribbon 120 is affixed to itself with applications of adhesive 140 between the presentation products 110 and at the free ends of ribbon 120. Adhesive 140 never makes contact with presentation products 110. Presentation products 110 enwrapped in ribbon 120 is then affixed to support structure 130 with applications of adhesive 150.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. The invention should not be construed as limited to the specific form shown and described, but instead as set forth in the following claims.

The invention claimed is:

1. A product presentation assembly comprising:
a presentation product,
a binding ribbon
an adhesive applied, and
a support structure.

2. A product presentation assembly as forth in claim 1, wherein:
said presentation product further comprises an anterior surface and a posterior surface,
said binding ribbon further comprises a first portion, a second portion, and a third portion, and enwraps said presentation product, and said first portion crosses the anterior surface of said presentation product,
said adhesive further comprises a first application and a second application,
said first application of adhesive binding said second portion and third portion of the binding ribbon, and
said second application of adhesive binding said binding ribbon to said support structure.

3. A product presentation assembly comprising:
a plurality of presentation products,
a binding ribbon
a first application of adhesive,
a second application of adhesive and
a support structure.

4. A product presentation assembly as forth in claim 3, wherein:
said binding ribbon further comprises a first portion, a second portion, and a third portion,
said first application of adhesive binds said first portion, second portion, and third portion of the binding ribbon, and
said second application of adhesive binds the binding ribbon to the support structure.

5. A product presentation assembly as forth in claim 4, wherein:
said presentation products are distributed approximately equally across the first portion of the binding ribbon, and
said first application of adhesive further comprises a plurality of applications of adhesive on the first portion of the binding ribbon between the presentation products.

6. A product presentation assembly as forth in claim 3 wherein:
said presentation product further comprises an anterior surfaces and a posterior surfaces,
said binding ribbon further comprises a first portion and a second portion, and enwraps said presentation product, and
said first portion crosses the anterior surface of said presentation products, and said second portion crosses the posterior surface of said presentation products,
said first application of adhesive binds said first portion of the binding ribbon to the second portion of the binding ribbon, and
said second application of adhesive binds said binding ribbon to said support structure.

7. A method of assembling a product presentation assembly comprising:
providing a binding ribbon having a first portion with a first end and a second portion with a second end,
distributing a plurality of presentation products along the length of the first portion of the binding ribbon,
enwrapping the presentation products by securing the second portion of the binding ribbon to the first portion of the binding ribbon with an adhesive agent, and
securing the binding ribbon to a support structure with an adhesive agent.

8. A method of assembling a product presentation assembly according to claim 7, wherein:
a first presentation product is positioned in the vicinity of the second portion of the binding ribbon and a presentation product is positioned leaving the first end exposed, and
the adhesive agent is applied onto the first portion of the ribbon between the presentation products and onto the first end.

9. A method of assembling a product presentation assembly comprising:
providing a binding ribbon having a first portion, a second portion and a third portion,
distributing a plurality of presentation products along the length of the first portion of the binding ribbon,
enwrapping the presentation products by securing the second portion of the binding ribbon to the first portion of the binding ribbon with an adhesive agent,
securing the third portion of the binding ribbon to the second portion of the binding ribbon with an adhesive agent, and
securing the binding ribbon to a support structure with an adhesive agent.

10. A method of assembling a product presentation assembly according to claim 9, wherein:
a first presentation product is positioned in the vicinity of the second portion of the binding ribbon and a final presentation product positioned in the vicinity of the third portion of the binding ribbon, and
the adhesive agent securing the second portion of the binding ribbon to the first portion of the binding ribbon is applied onto the first portion between the presentation products.
